(19) United States
(12) Patent Application Publication
(10) Pub. No.: US 2024/0326340 A1
(43) Pub. Date: Oct. 3, 2024

(54) PRINTING CONTROL METHOD, STORAGE MEDIUM, AND PHOTOCURING PRINTER

(71) Applicant: SHENZHEN ANYCUBIC TECHNOLOGY CO., LTD., Shenzhen (CN)

(72) Inventors: Xiaokang DENG, Shenzhen (CN); Jiangang CHEN, Shenzhen (CN)

(73) Assignee: SHENZHEN ANYCUBIC TECHNOLOGY CO., LTD., Shenzhen (CN)

(21) Appl. No.: 18/383,907

(22) Filed: Oct. 26, 2023

Related U.S. Application Data
(63) Continuation of application No. PCT/CN2023/095231, filed on May 19, 2023.

(30) Foreign Application Priority Data
Mar. 30, 2023 (CN) 202310365452.9

(51) Int. Cl. B29C 64/393; B29C 64/124; B29C 64/245; B33Y 10/00; B33Y 30/00; B33Y 50/02

(52) U.S. Cl. CPC B29C 64/393; B29C 64/124; B29C 64/245; B33Y 10/00; B33Y 30/00; B33Y 50/02

(57) ABSTRACT

A printing control method, a storage medium and a photocuring printer are provided. Through the method, the automatic leveling process for a photocuring printer is implemented without involving a manual operation so as to implement the automatic leveling for a photocuring printer while ensuring the printing quality, and the molding platform is controlled to move towards the resin vat by a first preset distance, which prevents errors of the system leveling result caused by the assembly error of mechanical structure so as to ensure the molding platform to fit evenly with the resin vat to meet the requirement of firm bonding of a cured printing material to the molding platform, which is conducive to improving the printing success rate of a model.

### CROSS REFERENCE TO THE RELATED APPLICATIONS

This application is a continuation application of International Application No. PCT/CN2023/095231, filed on May 19, 2023, which is based upon and claims priority to Chinese Patent Application No. 202310365452.9, filed on Mar. 30, 2023, the entire contents of which are incorporated herein by reference.

### TECHNICAL FIELD

The present application relates to the technical field of additive manufacturing, and in particular to a printing control method, a storage medium and a photocuring printer.

### BACKGROUND

A photocuring printer includes a frame, a light source, a molding platform, a vertical lifting mechanism and a resin vat. The vertical lifting mechanism drives the molding platform to move up and down in the resin vat filled with photocurable resin, and a slice image is projected to the bottom of the resin vat by means of the light source to allow the photocurable resin in the resin vat exposed to light to be subjected to polymerization to form a solid, with the photocurable resin not exposed to light remaining liquid, so as to achieve the purpose of creating a three-dimensional object layer-by-layer on a flat surface of the printing molding platform that faces the resin vat.

In existing photocuring printers, before printing a first layer, the molding platform needs to be in sufficient contact with the bottom of the resin vat, that is, the molding platform needs to fit with a bottom plate. In related art, it is generally manually identified whether the molding platform and the resin vat fit with the bottom plate. However, visual inspection has large errors, and manual leveling operations are some subjective and cumbersome and also difficult to guarantee the precision. If the leveling fails, a printed model cannot be bonded to the molding platform, resulting in a printing failure.

### SUMMARY

In view of this, the present application provides a printing control method, a storage medium and a photocuring printer, which solve the problem of complicated and low-precision operation for fitting and leveling of a molding platform and the bottom of a resin vat.

According to one aspect of the present application, a printing control method is provided, applied to a photocuring printer including a molding platform and a resin vat, the resin vat being configured to store a printing material. The method includes: controlling the molding platform to move towards the resin vat; controlling, if it is detected that the molding platform has reached the bottom of the resin vat, the molding platform to move towards the resin vat by a first preset distance; and controlling the photocuring printer to carry out exposure to print a first layer of a model to be printed.

According to another aspect of the present application, a storage medium is provided, storing a program or an instruction which, when executed by a processor, causes the printing control method mentioned above to be performed.

According to yet another aspect of the present application, a photocuring printer is provided, including a storage medium, a processor, and a computer program which is stored on the storage medium and runnable on the processor and which, when executed by the processor, causes the printing control method mentioned above to be performed.

With the technical solution described above, before the photocuring printer executes a printing task, the photocuring printer is leveled to ensure that the molding platform can fit with the bottom of the resin vat. Specifically, the molding platform is controlled to move towards the resin vat, and during the movement of the molding platform, it is detected whether the molding platform reaches the bottom of the resin vat, and if it is detected that the molding platform has reached the bottom of the resin vat, the molding platform is controlled to move towards the resin vat by the first preset distance. It should be understood that there is inevitably an assembly error in the mechanical structure of a photocuring printer. However, according to the present application, after it is detected that the molding platform has reached the bottom of the resin vat, the molding platform is controlled to continue to move towards the resin vat by the first preset distance, which can eliminate the mechanical assembly error of the photocuring printer to allow the molding platform to fit with the bottom of the resin vat as much as possible and can thus improve the firmness of bonding of the first layer of the model, and finally, the photocuring printer is controlled to carry out exposure to print the first layer of the model to be printed so as to carry out the printing task.

According to the technical solution provided by the present application, on one hand, an automatic leveling process for a photocuring printer is implemented without involving a manual operation, so as to implement the automatic leveling for the photocuring printer while ensuring the printing quality to effectively prevent a release film and a screen from being crushed. On the other hand, when it is detected that the molding platform has reached the bottom of the resin vat, the molding platform is controlled to move towards the resin vat by the first preset distance, which avoids the influence of the mechanical assembly error on the leveling result, ensures the molding platform to fit evenly with the resin vat to meet the requirement of firm bonding of a cured printing material to the molding platform, and prevents failure of firm bonding of the cured printing material to the molding platform caused by an excessively large gap between the molding platform and the resin vat due to unevenness, thereby improving the model printing effect and the model printing success rate.

### BRIEF DESCRIPTION OF THE DRAWINGS

The accompanying drawings described herein are intended to provide a further understanding of the present application, and form a part of the present application. The illustrative embodiments of the present application and the description thereof are for explaining the present application and do not unduly limit the present application. In the figures:

FIG. 1 is a schematic flowchart of a printing control method according to an embodiment of the present application;

FIG. 2 is a schematic flowchart of a printing control method according to a specific embodiment of the present application;

FIG. 3 is a schematic structural diagram of a leveling device according to an embodiment of the present application;

FIG. 4 is a schematic structural diagram of a photocuring printer according to an embodiment of the present application;

FIG. 5 is a schematic structural diagram of the photocuring printer according to the embodiment shown in FIG. 4, with a resin vat removed;

FIG. 6 is a schematic diagram of an upper bottom plate and a carrying mechanism in a fitting state in FIG. 5; and

FIG. 7 is a schematic exploded diagram of the upper bottom plate and the carrying mechanism in FIG. 5.

### LIST OF REFERENCE NUMERALS

510—molding platform, 520—resin vat, 521—bottom of resin vat, 522—outer frame of resin vat, 530—elastic structure, 540—upper bottom plate, 541—carrying mechanism, 5411—outer frame of carrying mechanism, 5412—screen assembly in carrying mechanism, 542—base, 550—lifting mechanism, 560—guide post.

### DETAILED DESCRIPTION OF THE EMBODIMENTS

The present application will be described below in detail with reference to the accompanying drawings and in conjunction with the embodiments. It should be noted that, in the case of no conflict, the embodiments and the features thereof in the present application can be combined with each other.

The embodiments of the present application will be described below in detail, and examples of the embodiments are shown in the drawings, with the same or similar reference numerals throughout the drawings representing the same or similar elements or the elements having the same or similar functions. The embodiments described below with reference to the accompanying drawings are exemplary merely intended to illustrate the present application, but shall not be construed as limiting the present application.

It should be understood by those skilled in the art that the singular forms “a”, “an” and “the” used herein may also include plural forms, unless specifically stated. It should be further understood that the word “including” used in the specification of the present application refers to the presence of a features, entities, steps, operations, elements and/or components, but does not exclude the presence or addition of one or more other features, entities, steps, operations, elements, components and/or combinations thereof. It should be understood that when an element is “connected” or “coupled” to a further element, it may be directly connected or coupled to further element, or an intermediate element may also be present. In addition, “connection” or “coupling” used herein may include a wireless connection or a wireless coupling. The phrase “and/or” used herein includes any or all of one or more related listed items and all combinations thereof.

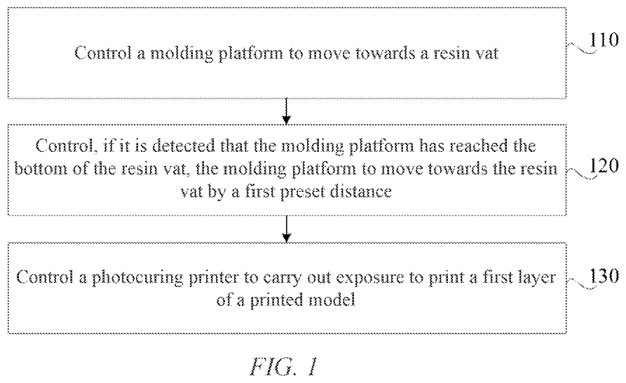

In this embodiment, a printing control method applied to a photocuring printer is provided. As shown in FIG. 1, the method includes the following steps.

At step 110, a molding platform is controlled to move towards a resin vat.

In this embodiment, the printing control method is applied to a photocuring printer which includes a molding platform 510 and a resin vat 520, as shown in FIGS. 4 to 7. The resin vat 520 is configured to store a printing material. The molding platform 510 is provided with an elastic structure 530 to allow the position of the molding platform 510 to be adjustable in a compression direction of the elastic structure 530, or a carrying mechanism 541 of the resin vat 520 is provided with the elastic structure 530 to allow the placement position of the resin vat 520 to be adjustable in the compression direction of the elastic structure 530. In this way, by means of the elastic structure 530, it is possible to prevent a release film and a screen from being crushed during the movement of the molding platform 510 towards the release film of the resin vat. It should be understood that the elastic structure 530 may be arranged on the molding platform 510 or on the carrying mechanism 541 of the resin vat 520 to achieve elastic adjustment of the side where the molding platform 510 is located or of the side where the resin vat 520, the release film and the screen are located, so that there is a space for elastic movement of the fitting flat surface between the molding platform 510 and the bottom of the resin vat, thus preventing the release film and the screen from being crushed during the movement of the molding platform 510 towards the bottom 521 of the resin vat 520.

In this embodiment, before the photocuring printer performs a printing task, the photocuring printer may be leveled to ensure that the molding platform can fit with the bottom of the resin vat. The molding platform is then controlled to move towards the resin vat to allow the molding platform to gradually approach the bottom of the resin vat, and then it is determined whether the molding platform reaches the bottom of the resin vat during the process of the molding platform gradually approaching the bottom of the resin vat.

It should be understood that the molding platform may be controlled to move towards the resin vat at a first preset speed, so as to achieve the effect of the molding platform moving at a constant speed, which can improve the stability of the molding platform during the movement. Moreover, the distance by which the molding platform moves can be conveniently determined from speed and time, and the movement at a constant speed can reduce detection errors caused by frequent speed changes, which is conducive to improving the accuracy of subsequent leveling.

It should be noted that, during the movement of the molding platform towards the resin vat, the resin vat may have no printing material therein or may be filled with the printing material, and the embodiments of the present application can be implemented in both cases. It should be understood that, when the resin vat is filled with a printing material, it is possible to determine the position of the first layer of a model to be printed and carry out exposure, and accurately determine the position of the first layer of the model to be printed during continuous printing of the model without removing the resin from the resin vat and accurately print the first layer of the model to be printed, thereby improving the convenience of user operation.

At step 120, if it is detected that the molding platform has reached the bottom of the resin vat, the molding platform is controlled to move towards the resin vat by a first preset distance.

In this embodiment, considering that, during the processing and manufacturing of the photocuring printer, there is inevitably an assembly error in a mechanical structure due to the precision problem of mechanical manufacturing, so that there is still a gap between the molding platform and the bottom of the resin vat when the system determines that the molding platform has reached the bottom of the resin vat. Therefore, after the molding platform has reached the bottom of the resin vat, the molding platform is controlled to move towards the resin vat by the first preset distance, so as to eliminate the influence of the mechanical assembly error of the printer itself on the leveling result and reduce the actual gap between the molding platform and the bottom of the resin vat, which ensures the tight fit between the molding platform and the release film at the bottom of the resin vat to allow the molding platform of the printer to be maintained as parallel as possible to the resin vat or the exposure screen so as to ensure that the printing material inside the gap can be completely cured and bonded to the bottom of the molding platform to facilitate separation from the resin vat. In addition, if it is detected that the molding platform has reached the bottom of the resin vat, the molding platform is controlled to continue to move towards the resin vat by the first preset distance, which can better ensure the molding platform to fit evenly and closely with the bottom of the resin vat, and can also compensate for the detection error when there is a small amount of error in the detection of whether the molding platform reaches the bottom of the resin vat, thereby ensuring the leveling effect.

In some specific embodiments, the first preset distance may be positively correlated with the difference between the maximum value and the minimum value of the range of errors of the mechanical assembly of the photocuring printer. In some specific embodiments, the first preset distance may be positively correlated with the compressible displacement of the elastic structure mounted on the photocuring printer.

In some embodiments, the first preset distance may be correlated with the machining precision of the photocuring printer and the user desired leveling accuracy. For example, in the production casting stage or the subsequent use of the photocuring printer, after the molding platform touches the bottom of the resin vat, the distance range of the gap created between the molding platform and the bottom of the resin vat due to misalignment is less than or equal to 0.4 mm, and then the first preset distance may be set to be greater than or equal to 0.4 mm. The touch between the molding platform and the bottom of the resin vat may be single-point touch or multi-point touch.

In a specific application scenario, as elaboration and extension of the specific implementation process of the embodiment described above, and in order to achieve complete description of the specific implementation process of this embodiment, detecting that the molding platform has reached the bottom of the resin vat in step 120 specifically includes the following steps.

At step 121, measuring a first measurement value for representing the force on the molding platform.

In a specific embodiment, the first measurement value may be measured by means of a force sensor, and the first measurement value may be a force value which can be used for representing the force on the molding platform relative to the resin vat. Specifically, the force sensor may be a pressure sensor, a strain gauge force sensor, a torsion sensor, etc., or the magnitude of driving current of an electric motor may be measured to reflect the magnitude of force on the molding platform, that is, the driving current of the electric motor may be taken as a first measurement value.

In some specific embodiments, the force sensor may be arranged in at least one of the positions on the molding platform, below the resin vat, between the carrying mechanism of the resin vat and the resin vat, and on a cantilever. The torsion sensor may be arranged at the connection between the electric motor and a lead screw, and a detector for the magnitude of current may be arranged in at least one of the electric motor and a driving circuit of the electric motor.

In some embodiments, in addition to the force sensor, a photoelectric sensor, a touch sensor, a visual sensor, motor travel measurement, a height sensor, etc. may also be provided to detect whether the molding platform reaches the bottom of the resin vat, which can improve the universality of the printing control method. During the process of detecting whether the molding platform reaches the bottom of the resin vat, the measurement value measured by means of the corresponding sensor is a first measurement value which may be an ON/OFF value or a specific value. The molding platform reaching the bottom of the resin vat may mean that the molding platform touches the resin vat, the molding platform abuts against the resin vat, the molding platform reaches the bottom of the resin vat in position, etc., depending on specific application scenarios. The bottom of the resin vat is at the position where the bottom of an accommodating cavity formed by the resin vat is located or at the position where the bottom of the resin vat is located. In some embodiments, the bottom of the resin vat is at the position of the side, facing the molding platform, of the release film at the bottom of the resin vat.

In some embodiments, determining that the molding platform has reached the bottom of the resin vat by means of the photoelectric sensor may include determining that the molding platform has reached the bottom of the resin vat when the photoelectric sensor is blocked. The first measurement value may be ON when the photoelectric sensor is blocked, or be OFF when the photoelectric sensor is not blocked. The photoelectric sensor may be arranged on the molding platform and will be blocked by the bottom of the resin vat when the molding platform reaches the bottom of the resin vat, or the photoelectric sensor may be arranged at the bottom of the resin vat and will be blocked by the molding platform when the molding platform reaches the bottom of the resin vat.

In some embodiments, determining that the molding platform has reached the bottom of the resin vat by means of the touch sensor may include determining that the molding platform has reached the bottom of the resin vat when the touch sensor mounted on the molding platform touches the bottom of the resin vat, or determining that the molding platform has reached the bottom of the resin vat when the touch sensor mounted at the bottom of the resin vat touches the molding platform. The first measurement value may be ON when the touch sensor touches an external object, or be OFF when the touch sensor does not touch an external object.

In some embodiments, determining that the molding platform has reached the bottom of the resin vat by means of the visual sensor may include determining that the molding platform has reached the bottom of the resin vat by means of visual detection. The first measurement value may be ON upon detecting a corresponding visual signal indicating that the molding platform has reached the bottom of the resin vat, or be OFF upon detecting no corresponding visual signal indicating that the molding platform has reached the bottom of the resin vat.

In some embodiments, determining that the molding platform has reached the bottom of the resin vat by means of motor travel measurement may include recording/measuring the current travel distance from a first preset position to the current position in real time during downward pressing of the molding platform from the first preset position, and determining that the molding platform has reached the bottom of the resin vat when the current travel distance reaches a preset travel distance. The first measurement value may be the current travel distance.

In some embodiments, determining that the molding platform has reached the bottom of the resin vat by means of the height sensor may include comparing a height coordinate of the molding platform with a height coordinate of the bottom of the resin vat, and determining that the molding platform has reached the bottom of the resin vat when the height difference between the height coordinate of the molding platform and the height coordinate of the resin vat is less than a preset height difference. The first measurement value may be the height difference between the height coordinate of the molding platform and the height coordinate of the bottom of the resin vat.

In some embodiments, step 121 of measuring a first measurement value for representing the force on the molding platform specifically includes the following steps.

At step 121-1, obtaining a no-load measurement value for representing the force on the molding platform when located outside the resin vat.

Specifically, the no-load measurement value for representing the force on the molding platform when located outside the resin vat may be obtained in the following manners.

In a first manner, a prestored no-load measurement value for representing the force on the molding platform when located outside the resin vat is obtained.

In a second manner, the molding platform is controlled to move towards the resin vat to a second position; and the molding platform is controlled to move by a third preset distance from the second position and away from the resin vat and then controlled to stop moving, and the measured measurement value for representing the force on the molding platform at this time is taken as the no-load measurement value. The second position is between the top and the bottom of the resin vat, and the third preset distance may be reasonably set according to the distance between the second position and the position where the top of the resin vat is located. That is to say, the molding platform is controlled to move to a position between the top and the bottom of the resin vat and then move out of the top of the resin vat in the opposite direction, which ensures that the current molding platform will not touch the resin vat or the printing material. The measurement value measured at this time is taken as the no-load measurement value. In this way, when the molding platform is above the top of the resin vat, that is, when the molding platform is located outside the resin vat, the measurement value measured at this time is taken as the no-load measurement value, which can avoid the influence of the buoyancy of the printing material in the resin vat on the first measurement value. When the molding platform fits evenly and closely with the bottom of the resin vat, there is no printing material between the molding platform and the resin vat and thus no influence of the buoyancy of the printing material, which can make the first measurement value obtained from the difference between the current measurement value and the no-load measurement value more accurate.

In a third manner, the molding platform is controlled to move towards the resin vat to a second preset position which is higher than the top of the resin vat; and when the molding platform moves to the second preset position, the measurement value for representing the force on the molding platform measured at this time is taken as the no-load measurement value. That is, the measurement value obtained when the molding platform cannot touch the resin vat or the printing material is taken as the no-load measurement value. Similarly, when the molding platform is above the top of the resin vat, the measurement value measured at this time is taken as the no-load measurement value, which can avoid the influence of the buoyancy of the printing material in the resin vat on the first measurement value. Moreover, according to this embodiment, it is also possible to avoid the need to control the molding platform to move back and forth to obtain the no-load measurement value, thereby improving the leveling efficiency.

At step 121-2, measuring the current measurement value for representing the force on the molding platform.

At step 121-3, the first measurement value is obtained from the difference between the current measurement value and the no-load measurement value.

In this embodiment, the no-load measurement value when the molding platform cannot touch the resin vat or the printing material is first obtained. In this way, the difference between the current measurement value collected during the movement of the molding platform and the no-load measurement value may approximatively reflect a force exerted by the resin vat or the printing material to the molding platform after the molding platform touches the resin vat or the printing material, and the difference between the current measurement value and the no-load measurement value may be taken as the first measurement value. Thus, the mechanical feedback of the molding platform may be accurately implemented according to the first measurement value, which is convenient for implementing the automatic leveling process for a photocuring printer according to the first measurement value without involving a manual operation, so as to reduce the leveling difficulty of the photocuring printer while ensuring the printing quality, thereby greatly saving labor costs.

At step 122, it is determined that the molding platform has reached the bottom of the resin vat when the first measurement value meets a first preset condition.

In this embodiment, during the process of the molding platform gradually approaching the resin vat, when the molding platform touches the bottom of the resin vat or the printing material loaded in the resin vat, the resin vat or the printing material exerts force to the molding platform, and the first measurement value will increase with the interaction force generated by the collision between the molding platform and the bottom of the resin vat, and when the first measurement value meets the first preset condition, indicating that the collision between the molding platform and the bottom of the resin vat can be determined according to the force on the molding platform, it is determined that the molding platform has reached the bottom of the resin vat. Therefore, the initial determination of whether the molding platform fits on the bottom of the resin vat is achieved on the basis of the mechanical feedback, so that the automatic leveling process for a photocuring printer is implemented without involving a manual operation, which reduces the leveling difficulty of the photocuring printer while ensuring the printing quality and can prevent the release film and the screen from being crushed.

The first preset condition may be a first measurement threshold that is reasonably set according to the force on the molding platform when touching the bottom of the resin vat. For example, if it is detected that the first measurement value is greater than or equal to the first measurement threshold, it can be determined that the molding platform has reached the bottom of the resin vat. It may also be determined that the molding platform has reached the bottom of the resin vat when the first measurement value measured by means of the photoelectric sensor, the touch sensor, the visual sensor, etc. is an ON signal, and determined that the molding platform has not reached the bottom of the resin vat when the measured first measurement value is an OFF signal.

In a specific embodiment, when the first measurement value is equal to the first measurement threshold, the force on an elastic structure on the carrying mechanism of the resin vat is smaller than the force that can make the elastic structure continue to compress. In this way, it is possible to prevent the molding platform from moving the bottom of the resin vat in the compression direction of the elastic structure when it is determined that the molding platform has touched the bottom of the resin vat when the first measurement value reaches the first measurement threshold. With the subsequent step of controlling the molding platform to move towards the resin vat by the first preset distance, it is possible to achieve accurate control of the leveling position and avoid the damage to the resin vat structure due to excessive movement of the resin vat bottom driven by the molding platform.

In some specific embodiments, step 122 of determining that the molding platform has reached the bottom of the resin vat when the first measurement value meets the first preset condition specifically includes the following steps.

At step 122-1, the molding platform is controlled to stop moving when the first measurement value meets the first preset condition.

At step 122-2, a second measurement value for representing the force on the molding platform is measured after a first preset duration for which the molding platform stops moving.

The first preset duration may be reasonably set according to the attribute parameters of the printing material, which will not be specifically limited in the embodiments of the present application. For example, the first preset duration is set as any duration in the range of 1 s to 5 s.

At step 122-3, it is determined that the molding platform has reached the bottom of the resin vat when the second measurement value meets a second preset condition.

The second preset condition may be a second measurement threshold that is reasonably set according to the force on the molding platform when touching the printing material. For example, if it is detected that the second measurement value is greater than or equal to the second measurement threshold, it can be determined that the molding platform has reached the bottom of the resin vat. It may also be a threshold corresponding to the measurement value obtained by means of the photoelectric sensor, the touch sensor, etc.

In this embodiment, it is considered that the printing material having fluidity will cause certain resistance to the molding platform during the movement of the molding platform so that the collected first measurement value includes a value of resistance of the printing material to the molding platform in addition to the value of actual force on the molding platform relative to the resin vat, thus causing erroneous determination. For this reason, in order to avoid the influence of the printing material on the first measurement value, when the first measurement value meets the first preset condition, the molding platform is controlled to stop moving, and the second measurement value for representing the force on the molding platform is measured again after the first preset duration for which the molding platform stops moving, so as to determine, according to the second measurement value, whether the resistance caused by the printing material to the molding platform during the stopping period of the molding platform decreases due to compression. When the second measurement value meets the second preset condition, indicating that the printing material has small influence on the force on the molding platform, that is to say, the influence of the resistance of the printing material can be eliminated, the collision between the molding platform and the bottom of the resin vat can be determined, and at this time, it is determined that the molding platform has reached the bottom of the resin vat. In this way, whether the molding platform has reached the bottom of the resin vat is calibrated again according to the second measurement value collected after the first preset duration for which the molding platform stops moving. Since the molding platform has stabilized in the printing material at this time and no longer move in the printing material, the influence of the resistance of the printing material on the leveling result can be avoided. In this way, the accuracy of determination of whether the molding platform reaches the bottom of the resin vat can be improved, thereby improving the leveling accuracy.

In some embodiments, if the second measurement value does not meet the second preset condition, it is indicated that the printing material has great influence on the force on the molding platform, and at this time, the leveling result of initial detection based on the first preset condition is not accurate. In order to make the molding platform fit with the bottom of the resin vat more closely, the molding platform is leveled more finely. Specifically, step 122 of determining that the molding platform has reached the bottom of the resin vat when the first measurement value meets the first preset condition further includes the following steps.

At step 122-4, when the second measurement value does not meet the second preset condition, at least one of the following steps is performed until the third measurement value meets the third preset condition or at least one of the number of times of performance of the step and the measurement distance meets a fourth preset condition: controlling the molding platform to move towards the resin vat at a second preset speed, and measuring a third measurement value for representing the force on the molding platform during the movement, the second preset speed being less than or equal to the first preset speed; obtaining the number of times of performance of the step of controlling the molding platform to stop moving; and measuring the measurement distance between the current position of the molding platform and the first preset position.

In other words, in some embodiments, step 122-4 may also include at least one of steps (1) to (3) as follows performed when the second measurement value does not meet the second preset condition.

At step (1), the molding platform is controlled to move towards the resin vat at the second preset speed, and the third measurement value for representing the force on the molding platform is measured during the movement until the third measurement value meets the third preset condition.

The second preset speed may be set to be less than or equal to the first preset speed. For example, when the second preset speed is less than the first preset speed, when the molding platform has touched the printing material, it is possible to avoid increased resistance of the printing material caused by the rapid movement of the molding platform and allow the molding platform to approach the bottom of the resin vat more and more slowly during gradual downward pressing so as to prevent the damage to the screen or the release film due to moving too fast, which is conducive to protecting the printer and can also reduce the resistance brought by the printing material to minimize the influence of the resistance brought by the printing material on the determination of whether the molding platform reaches the bottom of the resin vat so as to improve the leveling accuracy.

At step (2), the number of times of performance of the step of controlling the molding platform to stop moving until the number of times of performance of the step meets the fourth preset condition.

Specifically, the recording condition of the number of times of performance of the step of controlling the molding platform to stop moving may include either or both of the third measurement value meeting the third preset condition and the first measurement value meeting the first preset condition. For example, when the third measurement value meets the third preset condition and the molding platform is controlled to stop moving, the number of times of performance of the step may be accumulatively counted once, and when the first measurement value meets the first preset condition and the molding platform is controlled to stop moving, the number of times of performance of the step may be accumulatively counted once again; or only when the third measurement value meets a third preset condition and the molding platform is controlled to stop moving, the number of times of performance of the step is accumulatively counted once.

At step (3), the measurement distance between the current position of the molding platform and the first preset position is measured until the measurement distance meets the fourth preset condition.

Specifically, the first preset position includes the first position or the second position. The first position is a position of the molding platform when the step of controlling the molding platform to stop moving is performed when the first measurement value meets the first preset condition, that is, the position where the molding platform touches the printing material or approaches the bottom of the resin vat. The second position is a position between the top and the bottom of the resin vat, that is, any position inside the resin vat.

It should be noted that, in this embodiment, the second position may be the second position for determining the no-load measurement value in the embodiment described above. In this way, on the basis that the molding platform is pressed down to the second position during determination of the no-load measurement value, the molding platform is further pressed down by the measurement distance to meet the fourth preset condition, so that it is determined that the molding platform has reached the bottom of the resin vat, and thus the downward pressing stage after the second position may be performed on the basis of the downward pressing stage before the second position, which avoids repeated downward pressing and repeated calculation of the measurement distance, and determining the measurement distance on the basis of the second position can improve the efficiency of determination for the bottom of the resin vat.

In this embodiment, when the second measurement value does not meet the second preset condition, that is, the resistance of the printing material has great influence on the first measurement value, the molding platform may be controlled to continue to move towards the resin vat at the second preset speed lower than the first preset speed, and the compression for the printing material is adjusted until the molding platform fits evenly with the bottom of the resin vat, so that there is no influence of the printing material or only a small amount of printing material between the molding platform and the bottom of the resin vat, so as to eliminate the influence of the resistance of the printing material on the acting force between the molding platform and the bottom of the resin vat. Also, the third measurement value for representing the force on the molding platform is measured in real time during the further movement of the molding platform towards the resin vat.

In a specific embodiment, the portion from the first layer to a preset layer of the model to be printed is a base of the model to be printed. In this way, when there is no printing material or only a small amount of printing material between the molding platform and the bottom of the resin vat due to leveling, the body portion of the model will not be affected.

At step 122-5, the molding platform is controlled to stop moving when the third measurement value meets the third preset condition, and the second measurement value for representing the force on the molding platform is measured again after the first preset duration for which the molding platform stops moving.

In this way, it can be determined whether the molding platform is likely to be pressed down to the bottom of the resin vat by means of determining whether the third measurement value meets the third preset condition. If the third measurement value meets the third preset condition, indicating that the molding platform is likely to be pressed down to the bottom of the resin vat, the molding platform is controlled to stop moving for the first preset duration, and then the determination of whether a new second measurement value meets the second preset condition is made again, and if the new second measurement value meets the second preset condition, it is determined that the molding platform has reached the bottom of the resin vat. On the contrary, if the second measurement value does not meet the second preset condition, indicating that the printing material still has large resistance to the moving molding platform, that is, indicating that the molding platform does not in perfect fit with the bottom of the resin vat, the molding platform is controlled to compress again the printing material between the molding platform and the bottom of the resin vat. In this way, it is possible to ensure the molding platform to fit closely with the bottom of the resin vat so as to ensure the accuracy of the leveling result to allow the molding platform to fit evenly with the resin vat to meet the requirement of firm bonding of the cured printing material to the molding platform, which is conducive to improving the printing success rate of the model.

In a specific embodiment, after step 122-4 of performing at least one of the following steps when the second measurement value does not meet the second preset condition, the printing control method further includes the following steps. When the third measurement value is greater than or equal to the first measurement threshold, it is determined that the third measurement value meets the third preset condition, so that whether the third measurement value is greater than or equal to the first measurement threshold is taken as the third preset condition. When the third measurement value is greater than or equal to the first measurement threshold, it is indicated that after the molding platform moves multiple times, the printing material is compressed one or more times to reduce the influence of the printing material on the force on the molding platform, and the third measurement value being greater than or equal to the first measurement threshold indicates that the molding platform may be pressed down to the bottom of the resin vat. Specifically, the third measurement value and the first measurement value may be measured by means of the same or different sensors.

It should be noted that, in addition to taking the first measurement threshold as the third preset condition, the attribute parameters of the printing material may be obtained; the resistance value of the printing material is calculated according to the attribute parameters, the current temperature, and the second preset speed; and when the difference between the third measurement value and the resistance value is greater than or equal to the third measurement threshold, it is determined that the third measurement value meets the third preset condition. The attribute parameters of the printing material include information such as buoyancy and material. The third measurement threshold may be less than or equal to the first measurement threshold.

In this embodiment, when the attribute parameters of the printing material can be accurately obtained, the value of the resistance generated by the printing material in the current moving scenario may be estimated in combination with the multi-dimensional attribute parameters, the current temperature, and the second preset speed at which the molding platform moves. Therefore, a force measurement value that eliminates the influence of resin resistance is obtained from the difference between the third measurement value and the resistance value, and with the determination of whether the difference between the third measurement value and the resistance value reaches the third measurement threshold, it is possible to more accurately determine whether the molding platform moves down to the bottom of the resin vat, which can reduce the total number of downward pressing of the molding platform.

At step 122-6, when at least one of the number of times of performance of the step and the measurement distance meets the fourth preset condition, it is determined that the molding platform has reached the bottom of the resin vat.

In a specific embodiment, after step 122-4 of performing at least one of the following steps when the second measurement value does not meet the second preset condition, the printing control method further includes determining that at least one of the number of times of performance of the step and the measurement distance meets the fourth preset condition when the number of times of performance of the step is greater than or equal to a preset number of times or when the measurement distance is greater than or equal to the second preset distance.

The preset number of times may be reasonably set according to the second preset speed and a compressible space of the elastic structure. The second preset distance may be reasonably set according to the compressible space of the elastic structure.

In this embodiment, when meeting at least one of the two conditions, i.e., the number of times of performance of the step of controlling the molding platform to stop moving being greater than the preset number of times and the measurement distance of the molding platform being greater than or equal to the second preset distance, it is indicated that the higher the degree of compression of the printing material, the closer the molding platform is to the bottom of the resin vat, that is, after the molding platform moves multiple times, the compression for the printing material for multiple times reduces the influence of the printing material on the force on the molding platform, and at this time, it is determined that the fourth preset condition is met, and thus it is determined that the molding platform has reached the bottom of the resin vat. When the number of times of performance of the step is greater than or equal to the preset number of times or when the measurement distance is greater than or equal to the second preset distance, it is determined that the number of times of performance of the step meets the fourth preset condition, and thus it is determined that the molding platform has reached the bottom of the resin vat. In this way, it is possible to avoid the damage to the resin vat and the carrying mechanism of the resin vat due to the excessive downward pressing of the molding platform. In this way, it is possible to ensure the safety of the mechanical structure of the printer when the cured printing material is firmly bonded to the molding platform.

It should be noted that, at step 122-5 of measuring again the second measurement value for representing the force on the molding platform, whether the second measurement value meets the second preset condition is determined again. If the second measurement value meets the second preset condition again, it can be determined that the molding platform has reached the bottom of the resin vat; and if the second measurement value still does not meet the second preset condition, step 122-4 to step 122-6 are performed again.

In some embodiments, after step 120 of controlling, after it is detected that the molding platform has reached the bottom of the resin vat, the molding platform to move towards the resin vat by the first preset distance, the current position of the molding platform may be determined as the zero point of the molding platform, and the photocuring printer may be controlled to carry out exposure to print the first layer.

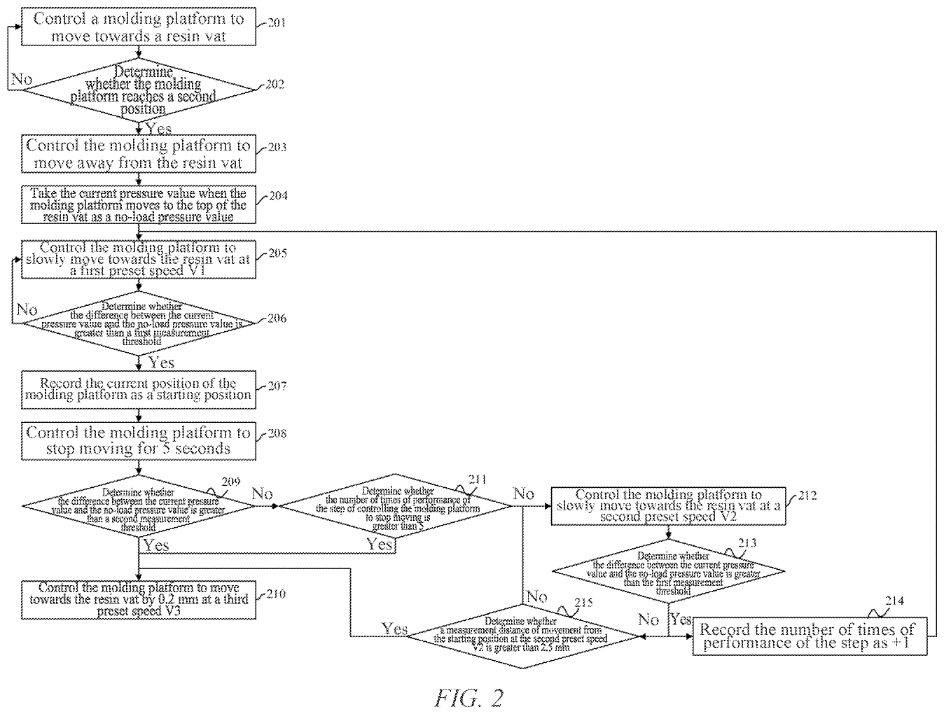

Specifically, for example, as shown in FIG. 2, the printing control method includes the following steps.

At step 201, a molding platform is controlled to move towards a resin vat.

At step 202, determining whether the molding platform reaches a second position, if yes, proceeding to step 203, and if not, returning to step 201.

The second position is between the top and the bottom of the resin vat.

At step 203, the molding platform is controlled to move away from the resin vat.

At step 204, when the molding platform moves to the top of the resin vat, a current pressure value is taken as a no-load pressure value.

At step 205, the molding platform is controlled to slowly move towards the resin vat at a first preset speed V1.

At step 206, determining whether the difference between the current pressure value and the no-load pressure value is greater than a first measurement threshold, if yes, proceeding to step 207, and if not, returning to step 205.

The current pressure value at step 206 is the first measurement value.

At step 207, the current position of the molding platform is recorded as a starting position.

At step 208, the molding platform is controlled to stop moving for 5 seconds;

At step 209, determining whether the difference between the current pressure value and the no-load pressure value is greater than a second measurement threshold, if yes, proceeding to step 210, and if not, proceeding to step 211.

The current pressure value at step 209 is the second measurement value.

The second measurement threshold is smaller than the first measurement threshold.

At step 210, the molding platform is controlled to move towards the resin vat by 0.2 mm at a third preset speed V3.

The third preset speed V3 is less than or equal to the second preset speed V2. In a specific embodiment, the third preset speed V3 may be far less than the first preset speed V1, so that the molding platform can move 0.2 mm towards the resin vat very slowly, which can avoid unnecessary damage to the resin vat or the carrying mechanism or the elastic structure of the resin vat during the movement of the molding platform towards the resin vat while ensuring the moving accuracy. In some embodiments, in addition to the distance of 0.2 mm, i.e., the first preset distance described in the above embodiment, that the molding platform is controlled to move towards the resin vat at the third preset speed V3, the first preset distance may also be reasonably set according to the compressible space of the elastic structure. For example, the first preset distance is less than or equal to the distance value of the compressible space of the elastic structure.

At step 211, determining whether the number of times of performance of the step of controlling the molding platform to stop moving is greater than 5, if yes, proceeding to step 210, and if not, proceeding to step 212.

At step 212, the molding platform is controlled to slowly move towards the resin vat at the second preset speed V2.

At step 213, determining whether the difference between the current pressure value and the no-load pressure value is greater than a first measurement threshold, if yes, proceeding to step 214, and if not, proceeding to step 215.

The current pressure value at step 213 is the third measurement value.

At step 214, the number of times of performance of the step is recorded as +1, proceeding to step 208.

At step 215, determining whether the measurement distance of movement from the starting position at the second preset speed V2 is greater than 2.5 mm, if yes, proceeding to step 210, if not, proceeding to step 212.

In this embodiment, the leveling result is calibrated according to the number of times of performance of the step and the measurement distance, it is also possible to avoid the damage to the resin vat and the carrying mechanism of the resin vat due to excessive downward pressing of the molding platform. After the system leveling, the molding platform is moved 0.2 mm as the first preset distance, so as to prevent errors of the system leveling result caused by mechanical assembly errors, thereby effectively improving the leveling accuracy.

On the basis of the embodiments described above, in some embodiments, the molding platform is provided with an elastic structure to allow the position of the molding platform to be adjustable in the compression direction of the elastic structure, or the carrying mechanism of the resin vat is provided with an elastic structure to allow the position of the bottom of the resin vat to be adjustable in the compression direction of the elastic structure, the carrying mechanism being configured to carry at least part of the structure of the resin vat.

In this way, since the molding platform is provided with the elastic structure to allow the position of the molding platform to be adjustable in the compression direction of the elastic structure, or the carrying mechanism of the resin vat is provided with the elastic structure to allow the position of the bottom of the resin vat to be adjustable in the compression direction of the elastic structure, so that when the molding platform is controlled to move the first preset distance towards the resin vat, the molding platform may gradually fit evenly with the bottom of the resin vat, and the deformation caused by collision/compression between the molding platform and the bottom structure of the resin vat can be avoided, so as to achieve convenient and reliable leveling within the elastically compressible range of the elastic structure.

In some embodiments, the portion of the carrying mechanism that is configured to carry the release film at the bottom of the resin vat may be a screen assembly. In this way, with the arrangement of the elastic structure on the carrying mechanism of the resin vat to allow the position of the bottom of the resin vat to be adjustable in the compression direction of the elastic structure, when the molding platform is controlled to move towards the resin vat by the first preset distance, the molding platform may gradually fit evenly with the bottom of the resin vat and the screen assembly of the resin vat, which can achieve a better model printing effect and can prevent the release film and the screen from being crushed during the downward pressing of the molding platform, thereby improving the structural safety of equipment.

In some embodiments, instead of the arrangement as described above of providing the elastic structure on the molding platform or providing the elastic structure on the carrying mechanism of the resin vat, there is an elastically compressible space at the bottom of the resin vat itself or there is an elastically compressible space at the printing surface of the molding platform, so that when the molding platform is controlled to move towards the resin vat by the first preset distance, the fitting flat surface between the bottom of the resin vat and the molding platform can move within a movable range. It should be understood that the material of the release film at the bottom of the resin vat has a certain elastically compressible space, and the printing flat surface of the molding platform may also have a certain elastically compressible space due to the arrangement of a coating, a cladding or an elastic layer. In this way, in the presence of the elastically compressible space described above, moving by the first preset distance can ensure the molding platform to fit evenly with the resin vat, which prevents failure of firm bonding of the cured printing material to the molding platform caused by an excessively large gap between the molding platform and the resin vat due to unevenness, thereby improving the model printing effect and the model printing success rate.

In a specific embodiment, as shown in FIGS. 4 to 7, the carrying mechanism 541 of the resin vat 520 is provided with the elastic structure 530 to allow the position of the release film at the bottom 521 of the resin vat to be adjustable in the compression direction of the elastic structure 530, and the carrying mechanism 541 is configured to carry at least part of the structure of the resin vat 520. The photocuring printer further includes an upper bottom plate 540 mounted on a base 542 of the photocuring printer.

In some embodiments, the carrying mechanism 541 is elastically connected to the upper bottom plate 540 by means of the elastic structure 530 to enable the carrying mechanism 541 to move relative to the position of the upper bottom plate 540, and the resin vat 520 is fixedly connected to the carrying mechanism 541 to allow the overall position of the resin vat 520, including the position of the release film at the bottom 521 of the resin vat 520, to be adjustable in the compression direction of the elastic structure 530, that is, the placement position of the resin vat 520 can be adjusted in the compression direction of the elastic structure 530. The compression direction of the elastic structure 530 is limited by the guiding direction of guide posts 560 on the upper bottom plate 540. The guiding direction of the guide posts 560 may be perpendicular to a carrying flat surface of the carrying mechanism 541, such that the compression direction of the elastic structure 530 remains perpendicular to the carrying flat surface of the carrying mechanism 541. In addition, the carrying mechanism 541 may also be connected to the upper bottom plate 540 by means of height limiting members (not shown) provided at four corners of the carrying mechanism 541, the height limiting members including studs and nuts. The studs of the height limiting members are inserted into through holes in the upper bottom plate 540, through holes in the carrying mechanism 541 and through holes in a plate-shaped metal piece and screwed at the ends of the studs by means of the nuts to limit the relative movement between the carrying mechanism 541 and the upper bottom plate 540 in a length direction of the studs, so that the range of the relative moving distance between the upper bottom plate 540 and the carrying mechanism 541 is limited within a first height, and when the distance between the upper bottom plate 540 and the carrying mechanism 541 reaches the maximum height, i.e., the first height, the elastic structure 530 is still in a compressed state to allow the elastic structure 530 in a natural state to elastically exert force away from the upper bottom plate 540 to the carrying mechanism 541, so that the distance between the upper bottom plate 540 and the carrying mechanism 541 reaches the maximum distance, so as to reserve a compressible space for the compression of the elastic structure 530 when the molding platform 510 subsequently approaches the bottom 521 of the resin vat 520.

In some specific embodiments, the plate-shaped metal piece may include at least two through holes, the height limiting members includes at least two studs and at least two nuts, four corners of the upper bottom plate 540 are also each provided with at least two through holes, and the four corners of the carrying mechanism 541 are also each provided with at least two through holes, so that during the connection of the carrying mechanism 541 to each of the four corners of the upper bottom plate 540, height limitation is achieved by means of at least two studs and at least two nuts, and the limitation in the direction perpendicular to the length direction of the studs may also be achieved by means of the plate-shaped metal piece through which the at least two studs passes, so as to limit the relative movement between the carrying mechanism 541 and the upper bottom plate 540 in a horizontal direction of the photocuring printer. The resin vat 520 may be fixedly connected to the carrying mechanism 541 by means of screwing, such that an outer frame 522 of the resin vat 520 abuts against an outer frame 5411 of the carrying mechanism 541, and the release film at the bottom 521 of the resin vat 520 fits on the screen assembly 5412 in the carrying mechanism 541. The screen assembly 5412 is configured to display a printed image to cure the curable material at the bottom 521 of the resin vat 520.

Alternatively, in other embodiments, the outer frame of the resin vat is fixedly connected to the upper bottom plate by means of screwing or in other feasible fixing manners, and the carrying mechanism is elastically connected to the upper bottom plate by means of the elastic structure to allow the carrying mechanism to be movable relative to the position of the upper bottom plate, and the carrying mechanism is configured to carry the release film at the bottom of the resin vat to allow the position of the release film at the bottom of the resin vat to be adjustable in the compression direction of the elastic structure during downward pressing of the molding platform.

As described in the above embodiments, the elastic structure may include, but not limited to, at least one of a spring, a spring plate, a compression spring, rubber, an elastic membrane and silicone, or other structures that can provide elasticity. For example, the spring separately connected to the carrying mechanism and the upper bottom plate provides elasticity for the relative movement between the carrying mechanism and the upper bottom plate. The plate-shaped metal piece as described in the above embodiments is a spring plate separately connected to the carrying mechanism and the upper bottom plate to provide elasticity for the relative movement between the carrying mechanism and the upper bottom plate, etc.

At step 130, the photocuring printer is controlled to carry out exposure to print the first layer of the model to be printed.

When the first layer of the model to be printed is printed, the first layer may be printed when the molding platform fit evenly and closely with the release film of the resin vat, and at this time, there may be no printing material between the molding platform and the release film of the resin vat; or a small amount of printing material may remain between the molding platform and the release film of the resin vat.

With the technical solution provided by the embodiments of the present application, when the system determines that the molding platform has reached the bottom of the resin vat and the assembly error of the mechanical structure has been eliminated, that is, the printer leveling is completed, the photocuring printer is controlled to carry out exposure to print the first layer of the model to be printed to execute a printing task. On the one hand, the automatic leveling process for a photocuring printer is implemented without involving a manual operation, so as to reduce the leveling difficulty of the photocuring printer while ensuring the printing quality to effectively prevent the release film and the screen from being crushed. On the other hand, after the system determines the leveling result, the molding platform is controlled to move towards the resin vat by the first preset distance, which eliminates the errors of the system leveling result caused by the mechanical assembly errors to effectively improve the leveling accuracy, ensures the molding platform to fit evenly with the resin vat to meet the requirement of firm bonding of the cured printing material to the molding platform, and prevents failure of firm bonding of the cured printing material to the molding platform caused by an excessively large gap between the molding platform and the resin vat due to unevenness, thereby improving the printing success rate of the model.

According to the embodiments of the present application, on the one hand, the automatic leveling process for a photocuring printer is implemented without involving a manual operation, so as to implement the automatic leveling for the photocuring printer while ensuring the printing quality to effectively prevent the release film and the screen from being crushed. On the other hand, when it is detected that the molding platform has reached the bottom of the resin vat, the molding platform is controlled to move towards the resin vat by the first preset distance, which avoids the influence of the mechanical assembly error on the leveling result, ensures the molding platform to fit evenly with the resin vat to meet the requirement of firm bonding of a cured printing material to the molding platform, and prevents failure of firm bonding of the cured printing material to the molding platform caused by an excessively large gap between the molding platform and the resin vat due to unevenness, thereby improving the model printing effect and the model printing success rate. The fitting of the molding platform evenly with the resin vat may mean that the molding platform fits evenly with the resin vat without a gap, or mean that the maximum gap between the molding platform and the resin vat is smaller than a preset gap. The preset gap is smaller than the height of a single layer of the model, which can prevent failure of firm bonding of the printing material to the molding platform during the printing process.

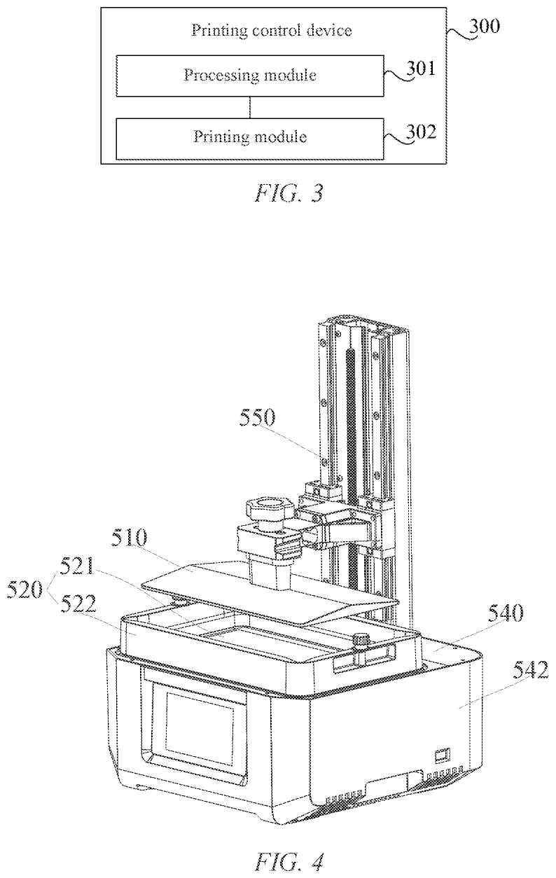

As shown in FIG. 3, as a specific implementation of the above printing control method, an embodiment of the present application provides a printing control device 300. The printing control device 300 includes a processing module 301 and a printing module 302.

The processing module 301 is configured to control the molding platform to move towards the resin vat, and control, if it is detected that the molding platform has reached the bottom of the resin vat, the molding platform to move towards the resin vat by a first preset distance.

The printing module 302 is configured to control the photocuring printer to carry out exposure to print a first layer of a model to be printed.

For the specific definition to a leveling device, reference can be made to the forgoing definition to the printing control method, which will not be repeated herein. All or some of the modules in the leveling device described above may be implemented by software, hardware and a combination thereof. The modules mentioned above may be embedded in or independent of the processor in the photocuring printer in the form of hardware, or may be stored in a memory of the photocuring printer in the form of software, so that the processor can invoke and execute the corresponding operations of the modules mentioned above.

It should be noted that, for other corresponding description of functional modules in a printing control device provided in this embodiment of the present application, reference can be made to the corresponding description in FIGS. 1 and 2, which will not be repeated herein.

Based on the printing control method shown in FIGS. 1 and 2 and the embodiment of the printing control device shown in FIG. 3, in order to achieve the foregoing objective, the embodiments of the present application further provide a photocuring printer. The photocuring printer includes: a storage medium and a processor; a storage medium configured to store a computer program; and a processor configured to execute the computer program to implement the foregoing printing control method as shown in FIGS. 1 and 2.

Optionally, as elaboration and extension of the specific implementation of the embodiment described above, for complete description of the specific implementation process of this embodiment, as shown in FIGS. 4 and 5, the photocuring printer includes a molding platform 510, a resin vat 520, an upper bottom plate 540 and a lifting mechanism 550. The resin vat 520 is configured to store a printing material. The molding platform 510 is arranged on the lifting mechanism 550 in a liftable manner, and the lifting mechanism 550 is arranged on the upper bottom plate 540 to drive the molding platform 510 to move up and down. The resin vat 520 is detachably mounted on the carrying mechanism 541 on the upper side of the upper bottom plate 540.

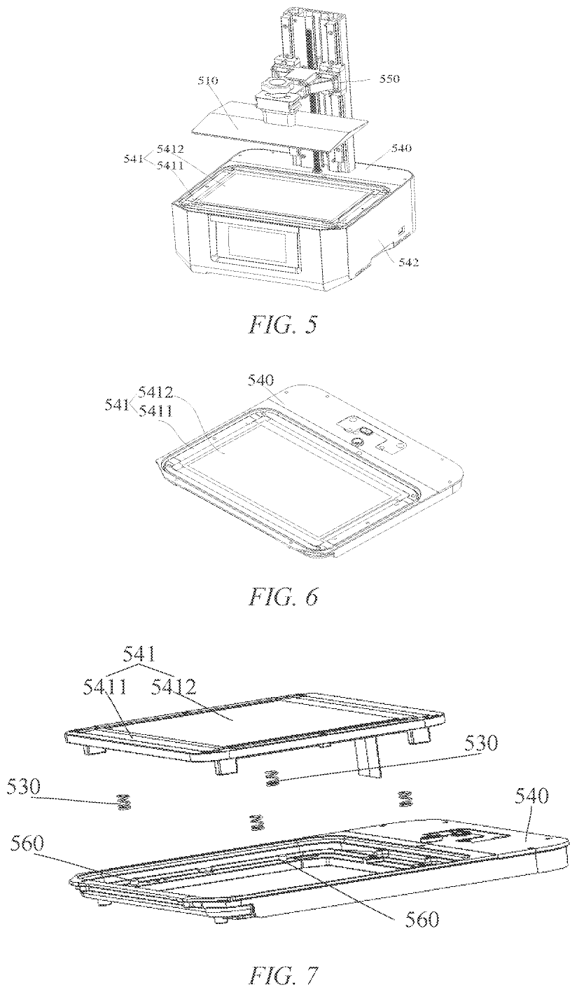

Optionally, the molding platform 510 is provided with an elastic structure 530 to allow the position of the molding platform 510 to be adjustable in a compression direction of the elastic structure 530, or, as shown in FIGS. 6 and 7, the carrying mechanism 541 of the resin vat 520 is provided with an elastic structure 530 to allow the position of the bottom 521 of the resin vat 520 to be adjustable in a compression direction of the elastic structure 530, so that the elastic structure 530 prevents the molding platform 510 from crushing a release film and a screen, and the elastic structure 530 can provide a compressible adjustable elastic movement space for the surface of the molding platform 510 that fits on the bottom 521 of the resin vat 520. The specific embodiment of the photocuring printer corresponds to the structures of the photocuring printer described in the embodiment of the printing control method, which will not be described in detail herein.

In a specific application scenario, the photocuring printer may be an LCD photocuring 3D printer or a projection photocuring 3D printer.

It should be understood by those skilled in the art that the structure of a photocuring printer provided in this embodiment does not constitute the limitation on the photocuring printer. The photocuring printer may include more or fewer components, or some components may be combined, or there may be a different component arrangement.

On the basis of the foregoing printing control method as shown in FIGS. 1 and 2, correspondingly, an embodiment of the present application further provides a storage medium storing a computer program which, when executed by a processor, causes the foregoing printing control method as shown in FIGS. 1 and 2 to be performed.

Based on such understanding, the technical solutions in the present application may be embodied in the form of a software product or a hardware product or a combination of software and hardware. The software product may be stored in a non-volatile storage medium (which may be a CD-ROM, a USB flash drive, a removable hard disk, etc.), and includes a plurality of instructions to cause a photocuring printer to perform the methods in various application scenarios of the present application.

The storage medium may further include an operating system and a network communication module. The operating system is a program that manages and stores hardware and software resources of the photocuring printer, and supports the running of information processing programs and other software and/or programs. The network communication module is configured to implement the communication between various controls inside the storage medium, as well as the communication with other hardware and software in this physical device.

By means of the foregoing description of the implementations, those skilled in the art may clearly understand that the present application may be implemented by software plus a necessary general-purpose hardware platform, or may be implemented by hardware.

What is claimed is:

1. A printing control method, wherein the printing control method is applied to a photocuring printer, the photocuring printer comprises a molding platform and a resin vat, the resin vat is configured to store a printing material, the method comprising:
controlling the molding platform to move towards the resin vat;
controlling the molding platform to move towards the resin vat by a first preset distance when the molding platform is detected reaching a bottom of the resin vat; and
controlling the photocuring printer to carry out an exposure to print a first layer of a model to be printed.

2. The printing control method according to claim 1, wherein the molding platform is provided with an elastic structure to allow a position of the molding platform to be adjustable in a compression direction of the elastic structure, or a carrying mechanism of the resin vat is provided with an elastic structure to allow a position of the bottom of the resin vat to be adjustable in the compression direction of the elastic structure, the carrying mechanism is configured to carry at least part of a structure of the resin vat; and a step the molding platform is detected reaching the bottom of the resin vat comprises:
measuring a first measurement value for representing a force on the molding platform; and
determining the molding platform reaching the bottom of the resin vat when the first measurement value meets a first preset condition.

3. The printing control method according to claim 2, wherein the step of determining the molding platform reaching the bottom of the resin vat when the first measurement value meets the first preset condition comprises:
controlling the molding platform to stop moving when the first measurement value meets the first preset condition;
measuring a second measurement value for representing the force on the molding platform after a first preset duration of the molding platform stopping moving; and
determining the molding platform reaching the bottom of the resin vat when the second measurement value meets a second preset condition.

4. The printing control method according to claim 3, wherein the step of controlling the molding platform to move towards the resin vat comprises:
controlling the molding platform to move towards the resin vat at a first preset speed;
after measuring the second measurement value for representing the force on the molding platform, the step of determining the molding platform reaching the bottom of the resin vat when the first measurement value meets the first preset condition further comprises:
performing at least one of the following steps when the second measurement value does not meet the second preset condition until a third measurement value meets a third preset condition or until at least one of a number of times of a performance of the step of controlling the molding platform to stop moving and a measurement distance meets a fourth preset condition: controlling the molding platform to move towards the resin vat at a second preset speed, and measuring the third measurement value for representing the force on the molding platform during a movement, wherein the second preset speed is less than or equal to the first preset speed; obtaining the number of times of the performance of the step of controlling the molding platform to stop moving; measuring the measurement distance between a current position of the molding platform and a first preset position;
controlling the molding platform to stop moving when the third measurement value meets the third preset condition, and measuring again the second measurement value for representing the force on the molding platform after the first preset duration of the molding platform stopping moving; and
determining the molding platform reaching the bottom of the resin vat when at least one of the number of times of the performance of the step and the measurement distance meets the fourth preset condition.

5. The printing control method according to claim 4, wherein when the second measurement value does not meet the second preset condition, the printing control method further comprises:
determining the third measurement value meeting the third preset condition when the third measurement value is greater than or equal to a first measurement threshold.

6. The printing control method according to claim 4, wherein when the second measurement value does not meet the second preset condition, the printing control method further comprises:
determining at least one of the number of times of the performance of the step and the measurement distance meeting the fourth preset condition when the number of times of the performance of the step is greater than or equal to a preset number of times or when the measurement distance is greater than or equal to a second preset distance.

7. The printing control method according to claim 4, wherein a portion from the first layer to a preset layer of the model to be printed is a base of the model to be printed;
the first preset position comprises a first position or a second position;
the first position is a position of the molding platform when the step of controlling the molding platform to stop moving when the first measurement value meets the first preset condition is performed; and
the second position is a position located between a top and the bottom of the resin vat.

8. The printing control method according to claim 2, wherein the carrying mechanism of the resin vat is provided with the elastic structure to allow a position of a release film at the bottom of the resin vat to be adjustable in the compression direction of the elastic structure, the carrying mechanism is configured to carry at least part of the structure of the resin vat;
wherein the photocuring printer further comprises an upper bottom plate mounted on a base of the photocuring printer, wherein the carrying mechanism is elastically connected to the upper bottom plate through the elastic structure to allow the carrying mechanism to be movable relative to a position of the upper bottom plate, and the resin vat is fixedly connected to the carrying mechanism to allow an overall position of the resin vat, comprising the position of the release film at the bottom of the resin vat, to be adjustable in the compression direction of the elastic structure; or an outer frame of the resin vat is fixedly connected to the upper bottom plate, the carrying mechanism is elastically connected to the upper bottom plate through the elastic structure to allow the carrying mechanism to be movable relative to the position of the upper bottom plate, the carrying mechanism is configured to carry the release film of the resin vat to allow the position of the release film of the resin vat to be adjustable in the compression direction of the elastic structure during downward pressing of the molding platform;
wherein the step of measuring the first measurement value for representing the force on the molding platform comprises:
obtaining a no-load measurement value for representing the force on the molding platform when the molding platform located outside the resin vat;
measuring a current measurement value for representing the force on the molding platform; and
obtaining the first measurement value from a difference between the current measurement value and the no-load measurement value.

9. The printing control method according to claim 8, wherein the step of obtaining the no-load measurement value for representing the force on the molding platform when the molding platform located outside the resin vat comprises:
obtaining a prestored no-load measurement value for representing the force on the molding platform when the molding platform located outside the resin vat.

10. The printing control method according to claim 8, wherein the step of obtaining the no-load measurement value for representing the force on the molding platform when the molding platform located outside the resin vat comprises:
controlling the molding platform to move towards the resin vat to a second position, the second position is located between a top and the bottom of the resin vat; and controlling the molding platform to move by a third preset distance from the second position and away from the resin vat, controlling the molding platform to stop moving, taking a measurement value for representing the force on the molding platform measured at this time the molding platform to stop moving as the no-load measurement value.

11. The printing control method according to claim 8, wherein the step of obtaining the no-load measurement value for representing the force on the molding platform when the molding platform located outside the resin vat comprises:
controlling the molding platform to move towards the resin vat to a second preset position, the second preset position is higher than a top of the resin vat; and taking a measurement value for representing the force on the molding platform as the no-load measurement value, the measurement value is measured when the molding platform moves to the second preset position.

12. A storage medium storing a computer program, wherein when the computer program is executed by a processor, the printing control method according to claim 1 is performed.

13. A photocuring printer, comprising a storage medium, a processor, and a computer program stored on the storage medium and configured to be runnable on the processor, wherein when the computer program is executed by the processor, the printing control method according to claim 1 is performed.

14. The photocuring printer according to claim 13, wherein in the printing control method, the molding platform is provided with an elastic structure to allow a position of the molding platform to be adjustable in a compression direction of the elastic structure, or a carrying mechanism of the resin vat is provided with an elastic structure to allow a position of the bottom of the resin vat to be adjustable in the compression direction of the elastic structure, the carrying mechanism is configured to carry at least part of a structure of the resin vat; and a step the molding platform is detected reaching the bottom of the resin vat comprises:
measuring a first measurement value for representing a force on the molding platform; and
determining the molding platform reaching the bottom of the resin vat when the first measurement value meets a first preset condition.

15. The photocuring printer according to claim 14, wherein in the printing control method, the step of determining the molding platform reaching the bottom of the resin vat when the first measurement value meets the first preset condition comprises:
controlling the molding platform to stop moving when the first measurement value meets the first preset condition;
measuring a second measurement value for representing the force on the molding platform after a first preset duration of the molding platform stopping moving; and
determining the molding platform reaching the bottom of the resin vat when the second measurement value meets a second preset condition.

16. The photocuring printer according to claim 15, wherein in the printing control method, the step of controlling the molding platform to move towards the resin vat comprises:
controlling the molding platform to move towards the resin vat at a first preset speed;
after measuring the second measurement value for representing the force on the molding platform, the step of determining the molding platform reaching the bottom of the resin vat when the first measurement value meets the first preset condition further comprises:
performing at least one of the following steps when the second measurement value does not meet the second preset condition until a third measurement value meets a third preset condition or until at least one of a number of times of a performance of the step of controlling the molding platform to stop moving and a measurement distance meets a fourth preset condition: controlling the molding platform to move towards the resin vat at a second preset speed, and measuring the third measurement value for representing the force on the molding platform during a movement, wherein the second preset speed is less than or equal to the first preset speed; obtaining the number of times of the performance of the step of controlling the molding platform to stop moving; measuring the measurement distance between a current position of the molding platform and a first preset position;
controlling the molding platform to stop moving when the third measurement value meets the third preset condition, and measuring again the second measurement value for representing the force on the molding platform after the first preset duration of the molding platform stopping moving; and
determining the molding platform reaching the bottom of the resin vat when at least one of the number of times of the performance of the step and the measurement distance meets the fourth preset condition.

17. The photocuring printer according to claim 16, wherein in the printing control method, when the second measurement value does not meet the second preset condition, the printing control method further comprises:
determining the third measurement value meeting the third preset condition when the third measurement value is greater than or equal to a first measurement threshold.

18. The photocuring printer according to claim 16, wherein in the printing control method, when the second measurement value does not meet the second preset condition, the printing control method further comprises:
determining at least one of the number of times of the performance of the step and the measurement distance meeting the fourth preset condition when the number of times of the performance of the step is greater than or equal to a preset number of times or when the measurement distance is greater than or equal to a second preset distance.

19. The photocuring printer according to claim 16, wherein in the printing control method, a portion from the first layer to a preset layer of the model to be printed is a base of the model to be printed;
the first preset position comprises a first position or a second position;
the first position is a position of the molding platform when the step of controlling the molding platform to stop moving when the first measurement value meets the first preset condition is performed; and
the second position is a position located between a top and the bottom of the resin vat.

20. The photocuring printer according to claim 14, wherein in the printing control method, the carrying mechanism of the resin vat is provided with the elastic structure to allow a position of a release film at the bottom of the resin vat to be adjustable in the compression direction of the elastic structure, the carrying mechanism is configured to carry at least part of the structure of the resin vat;
wherein the photocuring printer further comprises an upper bottom plate mounted on a base of the photocuring printer, wherein the carrying mechanism is elastically connected to the upper bottom plate through the elastic structure to allow the carrying mechanism to be movable relative to a position of the upper bottom plate, and the resin vat is fixedly connected to the carrying mechanism to allow an overall position of the resin vat, comprising the position of the release film at the bottom of the resin vat, to be adjustable in the compression direction of the elastic structure; or an outer frame of the resin vat is fixedly connected to the upper bottom plate, the carrying mechanism is elastically connected to the upper bottom plate through the elastic structure to allow the carrying mechanism to be movable relative to the position of the upper bottom plate, the carrying mechanism is configured to carry the release film of the resin vat to allow the position of the release film of the resin vat to be adjustable in the compression direction of the elastic structure during downward pressing of the molding platform;
wherein the step of measuring the first measurement value for representing the force on the molding platform comprises:
obtaining a no-load measurement value for representing the force on the molding platform when the molding platform located outside the resin vat;
measuring a current measurement value for representing the force on the molding platform; and
obtaining the first measurement value from a difference between the current measurement value and the no-load measurement value.
